(19) United States
(12) Patent Application Publication
(10) Pub. No.: US 2006/0087602 A1
(43) Pub. Date: Apr. 27, 2006

(54) Polarizer and method for producing it

(76) Inventors: Terufusa Kunisada, Tokyo (JP); Satoru Kusaka, Tokyo (JP); Etsuo Ogino, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/258,202

(22) Filed: Oct. 26, 2005

(30) Foreign Application Priority Data
Oct. 27, 2004 (JP) P2004-312301

(51) Int. Cl. G02F 1/1335

(52) U.S. Cl. 349/96

(57) ABSTRACT

The polarizer of the invention has the following constitution: On a transparent substrate having a plurality of linear prismatic structures formed thereon to be parallel to each other, a plurality of tabular members parallel to each other are formed at a predetermined angle to the substrate surface. One edge of the tabular member is in contact with the substrate along the ridge direction of the linear prismatic structure. In the invention, the thin film structure has a transparent film that covers the tabular member on the side thereof opposite to that in contact with the substrate. Preferably, the dielectric film has a one- to four-layered structure.

### BACKGROUND OF THE INVENTION

1. Field of the Invention

The present invention relates to a polarizer usable in liquid-crystal display devices, optical recording instruments, optical sensors, optical communication devices and others, and in particular, to a thin film structure for polarizer having polarizing properties necessary for polarizers and to a method for producing it.

2. Related Art

A polarizer is an optical element for taking out a ray polarized in a specific direction from light that contains rays polarized in various directions, and various types of such polarizers having different structures and different functions are now put into practical use. For example, there are known a wire grid-type polarizer which comprises metal films divided and arranged as plural stripes parallel to each other; a polarizing glass plate which contains pillar-like silver particles having a high aspect ratio, dispersed in glass; a polarizer which is fabricated by alternately laminating island metal layers and dielectric layers and then stretching the resulting laminate; a polarizing film which is fabricated by stretching and orienting a polymer material; and a laminate polarizer which is fabricated by alternately laminating dielectric films and metal films and into which light is introduced through the cross section of the laminate structure.

A polarizer (polarizing plate) of the type as above is an indispensable element in liquid-crystal display devices. In the file of liquid-crystal display, technological innovation of optical systems for downsizing, weight reduction and increase in brightness thereof is now under way, and liquid-crystal display devices are remarkably popularized for various applications of business data display, home theater movie display, etc. In particular, a technique of increasing the display brightness of image display devices has significantly progressed owing to the increase in the brightness of the light sources used and to the increase in the light utilization efficiency by the use of polarization conversion elements.

However, the technique of brightness increase and down sizing has given a problem in that the temperature inside the devices increases. Accordingly, there is increasing a demand for good heat resistance of optical members, and in particular, optical members must have good durability at high temperatures.

For the polarizing plate in liquid-crystal display devices, generally used is an organic film with a dye as in JP-A 2002-296417. However, the heat resistance of the organic film-having polarizing plate is essentially poor since it uses an organic material. As a polarizing film of good heat resistance, a dye-containing polarizing film is utilized. However, the wavelength range for the polarizing film of the type is narrow, and this is therefore problematic in that its application is limited.

To solve the above problems, use of a wire grid-type polarizer is proposed. The wire grid-type polarizer is a polarizer having a structure of linear wires (fine metal wires) arranged regularly in a predetermined direction on a glass substrate. Since all the constitutive materials thereof are inorganic materials, the polarizer is characterized in that its heat resistance is good, being different from those comprising an organic material such as a dye-containing polarizer. The wire grid-type polarizers illustrated in U.S. Pat. No. 6,108,131 and U.S. Pat. No. 6,122,103 are especially suitable to this purpose.

However, constructing such a wire grid-type polarizer requires accurate control of wire thickness and wire-to-wire pitch. In particular, in case where a wire grid-type polarize for use in a visible light range is constructed, it is known that the polarizer of the type constructed must have an ultra-microstructure of such that the width of one wire and the space adjacent to it is on a level of not more than 210 nm. Accordingly, the construction needs a specific technique of photolithography, vapor phase etching or the like. These techniques require expensive equipment and complicated processes, and are therefore problematic in that the production costs are high.

When light is led into a wire grid-type polarizer comprising fine metal wires, then the rays of which the electric field amplitude face is parallel to the lengthwise direction of the fine metal wires (TE-mode light) is reflected on it while those of which the electric field amplitude face is perpendicular to the lengthwise direction of the fine metal wires (TM-mode light) passes through it, not reflected thereon, and to that effect, the polarized rays are separated through the polarizer. However, it is difficult to lower the reflectance of the TM-mode light within a broad wavelength range (for example, within a whole visible light wavelength range).

As a method for lowering the reflectance of the TM-mode light in a broad wavelength range while increasing the reflectance of the TE-mode light therein, JP-A 2003-502708 discloses a technique of providing an additional layer in the interface between the substrate and the fine metal wires and a technique of working the substrate surface for forming grooves therein.

On the other hand, as a method for lowering the reflectance of the TM-mode light in a broad wavelength range while increasing the reflectance of the TE-mode light therein in an “embedded wire grid-type polarizer” where fine metal wires are sandwiched between two substrates therein, disclosed are a technique of providing an additional layer in the interface between the substrate and the fine metal wires and a technique of working the substrate surface for forming grooves therein (see JP-A 2003-519818).

Further disclosed is a method of filling the space between metal wires with a low-refractive-index material and covering the side of the metal wires opposite to the substrate thereof with a transparent substrate. This method may be effective for enlarging the wavelength range where the polarizer could function, toward a short wavelength side, and its effect for lowering the reflectance of the TM-mode light on the polarizer and increasing the reflectance of TE-mode light thereon may be great.

The method disclosed in JP-A2003-502708 maybe effective for enlarging the wavelength range where the polarizer could function, toward a short wavelength side, but is still ineffective for lowering the reflectance of the TM-mode light on the polarizer and for increasing the reflectance of the TE-mode light thereon. For constructing this structure, the reference discloses a method of etching both the two different materials, the metal and a part of the substrate, at a time, or a method of providing an additional layer between the metal and the substrate followed by etching both the metal and the additional layer at a time. However, the method has a technical difficulty as including the step of etching both the two different materials at a time.

On the other hand, the method disclosed in JP-A 2003-519818 requires a substantially resinous material as the filler and is therefore defective in that the durability of the polarizer constructed may worsen. In particular, the polarizer of this reference may lose the advantage of good durability characteristic of a wire grid-type polarizer that is formed of inorganic materials. In addition, another problem with the polarizer is that it requires two sheets of optical glass and therefore its production costs are high.

### SUMMARY OF THE INVENTION

The present invention has been made for solving these problems, and its object is to provide a polarizer having a capability of polarization separation within abroad wavelength range. Another object of the invention is to provide such a polarizer that is easy to produce and has good thermal durability.

To solve the problems as above, the invention provides a polarizer provided with a thin film structure having a structure mentioned below. Specifically, on a transparent substrate having a plurality of linear prismatic structures formed thereon to be parallel to each other, a plurality of tabular members parallel to each other are formed at a predetermined angle to the substrate surface. One edge of the tabular member is in contact with the substrate along the ridge direction of the linear prismatic structure.

In the invention, a transparent film is formed to cover the tabular members on another edges thereof opposite to those in contact with the transparent substrate. The transparent film is so designed that the increase in the TM-mode polarization light transmittance of the thin film structure as compared with that of the thin film structure not having the transparent film is larger than the increase in the TE-mode polarization light transmittance thereof.

The transparent film functions as an antireflection film, and is effective for increasing the TM-mode light transmittance of the structure in a broad wavelength range not so much decreasing the extinction coefficient thereof, and therefore, it provides a polarizer having good polarization separation capability. In addition, since the thin film structure may be fabricated only in a film-forming process, its production is easy.

Preferably, the tabular member comprises, as the main component thereof, a metal material. Since such a one-directional metal layer is formed on the substrate, the structure may express good polarization capability.

Preferably, the tabular member is composed of a layer of mainly a metal material and a layer of mainly a dielectric material that are integrated to each other. In this, since the one-directional metal layer expresses good polarizing capability and since a dielectric layer is integrated to the metal layer, the durability of the thin film structure can be increased.

Preferably, the transparent film is a single-layered film formed of one and the same material alone or a multi-layered film formed of plural different materials. The transparent film of the type is effective for increasing the TM-mode light transmittance of the structure in a broad wavelength range not lowering the extinction coefficient thereof.

The transparent film maybe a single-layered film formed of one and the same material alone and its refractive index is preferably not more than 1.5. The transparent film may be a two-layered film formed of two different materials, and preferably, the refractive index of the first layer thereof on the side of the thin film structure is from 1.6 to 1.9 and the refractive index of the second layer thereof is not more than 1.5. The transparent film may also be a three-layered film formed of three different materials, and preferably, the refractive index of the first layer thereof on the side of the thin film structure is from 1.6 to 1.9, the refractive index of the second layer thereof is from 2.2 to 2.7 and the refractive index of the third layer thereof is not more than 1.5.

The transparent film having the film constitution as above is effective for increasing the TM-mode light transmittance of the structure in a broad wavelength range not lowering the extinction coefficient thereof.

The metal material to constitute the tabular member is preferably selected from silver, aluminum, copper, platinum, gold or an alloy comprising, as the main component thereof, any of these metals. The metal material of the type has a high reflectance on its surface, and is therefore favorable for use in the invention from the viewpoint that it is effective for increasing the TM-mode light transmittance of the structure in a broad wavelength range not lowering the extinction coefficient thereof.

Preferably, the dielectric material to constitute the dielectric layer of the tabular member is a material comprising, as the main component thereof, silicon dioxide, or a material comprising, as the main component thereof, magnesium fluoride. The dielectric material of the type is highly transparent in a broad wavelength range of from visible light range to UV range, and has a low refractive index, and therefore it readily exhibits good antireflection effect. Like the above-mentioned metal material, the dielectric material of the type also has good heat resistance and is therefore effective for improving the thermal durability of the polarizer comprising it.

Preferably, the space between the tabular members is filled with a transparent dielectric material having a refractive index of not more than 1.6. Thus filling the space with such a transparent material improves the durability of the polarizing having the structure. In addition, since the space is filled with the material, the surface unevenness of the thin film structure may be reduced, therefore facilitating the formation of a transparent film thereon. Further, since the dielectric material has a low refractive index, the transparent film formed may readily exhibit its good antireflection effect.

Even the wire grid-type polarizers disclosed in JP-A 2002-296417, U.S. Pat. No. 6,108, 131, U.S. Pat. No. 6,122,103 and JP-A 2003-502708 may have a lowered TE-mode light transmittance and an increased TE-mode light transmittance when their surface is coated with a transparent dielectric layer. In such a case, however, the wire-to-wire distance must be narrow. If the wire-to-wire distance is broad, then a transparent dielectric material may deposit in the broad distance when a layer of the material is formed and therefore the intended film profile could not be obtained. On the other hand, for narrowing the wire-to-wire distance, micropatterning photolithography is needed, and it increases the difficulty in fabricating the structure. To that effect, the method for fabricating the thin film structure of the invention that is described herein under is advantageous in that the space between the tabular members may be readily narrowed.

The polarizer of the invention that comprises a thin film structure having a tabular metal structure may be fabricated according to a method mentioned below. An ion, an atom or a cluster of a metal element is impinged on a linear prismatic structure formed on a substrate, at a predetermined angel to the ridge direction of the structure and in the direction oblique to the normal line of the substrate, while simultaneously an ion, a metal or a cluster of the metal element is also impinged on the linear prismatic structure on the opposite side thereof over the normal face parallel to the ridge direction of the prismatic structure, to thereby form, on the surface of the substrate, a tabular member comprising the metal as the main component thereof. Next, at least one transparent dielectric layer is subsequently formed on the tabular member according to a non-directional film-forming process.

The polarizer of the invention that comprises a thin film structure having a tabular member, in which the tabular member comprises a metal layer and a dielectric layer integrated to each other, may be fabricated according to a method mentioned below. Anion, an atom or a cluster of a metal element is impinged on a linear prismatic structure formed on a substrate, at a predetermined angel to the ridge direction of the structure and in the direction oblique to the normal line of the substrate, while simultaneously an ion, a metal or a cluster of an element to constitute a dielectric material is impinged on the linear prismatic structure on the opposite side thereof over the normal face parallel to the ridge direction of the prismatic structure, to thereby form, on the surface of the substrate, a tabular member comprising a layer of mainly the metal and a layer of mainly the dielectric material that are integrated to each other. Next, at least one transparent dielectric layer is subsequently formed on the tabular member according to a non-directional film-forming process.

According to the methods as above, a plurality of tabular members parallel to each other are formed on a transparent substrate having a plurality of linear prismatic structures formed thereon to be parallel to each other, at a predetermined angle to the substrate surface, and one edge of the tabular member is in contact with the substrate along the ridge direction of the linear prismatic structure thereof. A transparent film maybe formed to cover the tabular members on anther edges thereof that are opposite to those in contact with the transparent substrate. Since the methods comprise only the step of forming the thin film, the polarizer of the invention is easy to fabricate according to the methods.

In addition, in the methods, the TM-mode polarization light transmittance and the TE-mode polarization light transmittance of the thin film structure that comprises the tabular member formed on the surface of the substrate thereof may be determined as reference values, and the transparent dielectric layer may be so designed that the increase in the TM-mode polarization light transmittance of the structure as compared with the reference value thereof is larger than the TE-mode polarization light transmittance thereof. The transparent dielectric film is so designed as to have the constitution as above, and the film is formed under the condition to fabricate the polarizer of the invention.

The method of the invention comprises only a step of film formation, therefore producing a polarizer having good polarization separation capability and good thermal durability. In particular, the polarizer thus produced in the invention may have an extremely increased TM-mode light transmittance while still having a lowered TE-mode light transmittance. In addition, since the polarizer basically comprises inorganic materials, its thermal durability is high. Further, the method of producing the polarizer of the invention does not require photolithography, it enables production of large-area polarizers at low costs.

### BRIEF DESCRIPTION OF THE DRAWINGS

FIG. 1 is a schematic perspective view showing one example of a thin film structure not coated with a transparent film;

FIGS. 2A through 2C are schematic cross-sectional views of polarizers of the invention;

FIG. 3 is a schematic perspective view showing another example of a thin film structure not coated with a transparent film;

FIGS. 4A and 4B are schematic cross-sectional views of polarizers of the invention;

FIGS. 5A through 5D are schematic views showing a method for forming a substrate and showing examples of the profile of the substrate;

FIG. 6 shows a film-forming device for use in constructing a thin film structure of the invention; and

FIG. 7 shows a film-forming device for use in forming a transparent dielectric film.

### DETAILED DESCRIPTION OF THE PREFERRED EMBODIMENTS

The polarizer of the invention has been made for the purpose of increasing the TM-mode light transmittance in a wire grid-type polarizer. The TM-mode light as referred to herein means that, in an arrangement where the light coming-in face is perpendicular to the micro-wires of the wire grid, the electric field amplitude face of the light is parallel to the light coming-in face.

The invention has been attained on the basis of the finding that, when a transparent dielectric film is formed on the surface of a wire grid-type polarizer and when the transparent dielectric film is specifically so designed that it has an antireflection effect, then the TM-mode light transmittance through the structure can be remarkably increased.

Of a structure such as the wire grid-type polarizer where linear metal wires are regularly arranged in a predetermined direction on a transparent substrate of glass or the like, the macroscopic refractive index to TE-mode light is nearly the same as the refractive index of the metal. On the other hand, the macroscopic refractive index of the structure to TM-mode light is far smaller than the refractive index of the metal. Accordingly, the reflectance of the structure to TE-mode light is extremely large but that to TM-mode light is low. However, since the refractive index of the structure to TM-mode light is a limited value, the reflection on the interface of the structure is inevitable.

Given that situation, for the purpose of increasing the transmittance of the structure itself, it is desirable to lower the reflectance of the structure to TM-mode light. For this, employable is a method of providing a transparent film to cover the structure, and the film maybe limited in point of its suitable thickness and refractive index. First, the suitable refractive index is lower than the apparent refractive index of the supposed interface between the substrate and the wire grid. On the other hand, regarding the suitable film thickness, the optical thickness of the film corresponds to a thickness of λ/4 (where means the wavelength of the incident light).

Specifically, for the purpose of increasing the TM-mode light transmittance thereof by forming a film to cover the polarizer having the structure as above, it may be effective to form, on the polarizer, an antireflection film heretofore known as a member for increasing the transmittance of a transparent substrate. Needless-to-say, it is undesirable that the polarization separation capability of the polarizer is worsened by forming the film thereon, and the extinction coefficient that means the ratio of the TM-mode light transmittance to the TE-mode light transmittance of the structure must not lower.

Regarding the constitution of the film having an antireflection effect, any conventional film heretofore known as an antireflection film formable on a transparent substrate is employable herein with no specific limitation thereon. Some examples are mentioned below. These all show the film constitution of a transparent dielectric film layer to be formed on the surface of a wire grid provided on a substrate.
(1) Constitution of one low-refractive-index layer alone,
(2) Two-layer constitution of middle-refractive-index layer/low-refractive-index layer,
(3) Three-layer constitution of middle-refractive-index layer/high-refractive-index layer/low-refractive- index layer.

In case where a multi-layered film is formed on a wire grid, it is difficult to control the film profile and the film thickness since the surface of the wire grid structure is rough, and this difficulty increases along with the increase in the number of the layers to be laminated. Accordingly, the number of the layers to be laminated is preferably smaller.

The film thickness and the refractive index of each layer of the transparent dielectric film are not specifically defined, and their most suitable values vary depending on the structure, the size and the metal material of the wire grid, and the applicable wavelength range of the polarizer, and are not specifically defined.

To overcome the above difficulty, it may be effective to fill the space between the metal micro-wires of the wire grid-type polarizer with a transparent dielectric material for the purpose of flatten the surface of the structure, and a multi-layered film may be readily formed on the thus-smoothed surface. The transparent dielectricmaterial for this purpose may be various resin materials or sol-gel materials comprising SiO₂ as the main component thereof. However, from the viewpoint of increasing the ratio of the TM-mode light transmittance to the TE-mode light transmittance (extinction coefficient) of the structure, the refractive index of the filler material is preferably lower.

For forming the wire grid, herein employable are techniques of photolithography and vapor-phase etching. In this case, however, since the wire grid pitch depends on the accuracy in photolithography, the distance between metal micro-wires may be limited to 90 nm or so. Accordingly, it is difficult to form a smooth transparent dielectric film on the surface of the wire grid-type polarizer of this type.

Specifically, when a coating film is formed on the surface of a wire grid having a wire-to-wire pitch of more than 90 nm or so, then the film shall have a surface roughness profile that significantly reflects the periodic structure around the metal micro-wires. In such a case, it is desirable that the space between the metal micro-wires are filled with a resin or a sol-gel material so as to flatten the surface of the wire grid structure and then a transparent optical multi-layered film is formed on the thus-smoothed wire grid surface.

Another method maybe employable for forming a wire grid, which is as follows:

A linear prismatic structure is previously formed on a substrate, and an ion, an atom or a cluster of a metal element is impinged on it at a predetermined angel to the ridge direction of the structure and in the direction oblique to the normal line of the substrate, while simultaneously an ion, a metal or a cluster of the metal element is also impinged on the linear prismatic structure on the opposite side thereof over the normal face parallel to the ridge direction of the prismatic structure, to thereby form a film on the surface of the substrate.

According to the method, a thin film structure may be formed on the substrate, in which the tabular metal stands on the substrate along the prismatic structure of the substrate. The thin film structure of this type is also applicable to a wire grid. In the wire grid-type polarizer thus fabricated according to the method, the distance between the tabular metal parts depends on the pitch of the prismatic structures and the angle at which the metal particles are impinged on the substrate (the angle to the normal line of the substrate) Specifically, when the pitch of the prismatic structures is smaller or when the metal particles-impinging angle is smaller, then the distance between the tabular metal parts is narrower. When distance between the tabular metal parts is narrower, then it is desirable since the transparent dielectric film to be formed on the structure may be more readily flattened.

Still another method may be employable for forming a wire grid, which is as follows:

On the linear prismatic structure like the above, an ion, an atom or a cluster of a metal element is impinged at a predetermined angel to the ridge direction of the structure and in the direction oblique to the normal line of the substrate, while simultaneously an ion, a metal or a cluster of an element to constitute a dielectric material is also impinged on the linear prismatic structure on the opposite side thereof over the normal face parallel to the ridge direction of the prismatic structure, to thereby form a film on the surface of the substrate.

According to the method, a thin film structure may be formed on the substrate, in which tabular metal and dielectric material stand, while being integrated to each other on their backs, on the substrate along the prismatic structure of the substrate. The thin film structure of this type is also applicable to a wire grid.

In the wire grid-type polarizer of the type, the distance between the tabular metal parts depends on the pitch of the prismatic structures and the angle at which the constitutive particles of metal and dielectric material are impinged on the substrate (the angle to the normal line of the substrate). Specifically, when the pitch of the prismatic structures is smaller or when the angle at which the constitutive particles of metal and dielectric material impinge on the substrate is smaller, then the distance between the tabular metal parts is narrower.

This method is most preferred for the viewpoint of narrowing the width of the tabular metal parts and for narrowing the distance between the tabular metal parts, and this is a method for fabricating a wire grid suitable to the invention.

When distance between the tabular metal parts is narrower, then it is desirable since the transparent dielectric film to be formed on the structure may be more readily flattened.

The metal material to be used is preferably platinum, gold, silver, copper, aluminum, or an alloy comprising, as the essential ingredients thereof, any of these metals, from the viewpoint of the optical properties of the polarizer.

For forming the prismatic structure of the substrate, preferred is a molding method as it is simple. A sol or gel transparent material such as a metal alkoxide sol or gel is applied onto a substrate, and shaped under pressure by the use of a shaping mold that has a plurality of parallel linear prismatic profiles engraved on its inner surface, and baked to thereby form a prismatic structure that comprises mainly silicon dioxide (SiO₂) and has good weather resistance. A part from it, the molding method is also applicable to a resin material, as well known in the art.

However, the invention should not be limited to the method as above. Another method of photolithography is also employable herein. In this, a technique of image drawing with electronic rays or interference exposure to light may be employed for patterning. According to the technique, a photoresist or the like is exposed to light and developed to form a pattern, and using the pattern as a mask, a substrate material is etched to thereby obtain a desired prismatic structure.

Still another method is also employable, which comprises polishing the surface of a substrate with abrasive grains or the like, and the roughened surface thus formed in the method may be employed in the invention. However, when the surface-roughened substrate is formed according to the method, then, in general, it is difficult to form a deep prismatic structure. In particular, when the surface is roughened with abrasive grains, then the roughened surface may have only a shallow prismatic structure.

It is found that, when a transparent dielectric material is impinged onto the substrate having such a shallow prismatic surface structure at a predetermined angle to the prismatic structure of the and in the direction oblique to the normal line of the substrate surface, then the tabular transparent dielectric structure thus formed may augment the prismatic structure of the substrate. In addition, it is found that, when a dielectric material is impinged on a substrate in two directions opposite to each other via the normal face of the substrate therebetween both at a predetermined direction to the substrate, then the prismatic structure of the substrate may also be augmented by it.

According to the method, it is possible to improve a shallow prismatic structure of a substrate into a deep prismatic structure thereof by means of the transparent dielectric film that covers it. When a metal is impinged on the substrate having such a film, in an oblique direction thereof to form a film thereon, then a thin film structure having a polarizing function is easy to construct.

A wire grid-type polarizer having a space therein has a problem of durability in that the tabular metal to express the polarization capability may be oxidized or may be aged into fine particles. In this respect, it is favorable to cover the surface of the thin film structure with a transparent dielectric material for remarkably improving the durability of the structure. The coating method for it is not specifically defined, and various methods of liquid application, chemical vapor phase growth or physical film formation are employable with no specific limitation. However, in view of the necessity of strict control of the film thickness, a method of physical film formation is the best.

Embodiments of the invention are described below with reference to the drawings attached hereto. In the drawings, the same members are represented by the same numeral reference or the same symbol, and their repetitive description may be omitted.

### First Embodiment

The first embodiment of the invention is a polarizer for use in a visible light wavelength range, which comprises, as the basic structure thereof, a thin film structure A mentioned below of tabular parts formed on a prismatic structure surface-having substrate and in which the tabular parts each are formed of a dielectric layer and a metal layer combined in contact with each other and are periodically aligned in lines. A method for constructing it is described in the following Examples.

(Thin Film Structure A)

A method for constructing the thin film structure for use in this embodiment and the properties of the structure are described below.

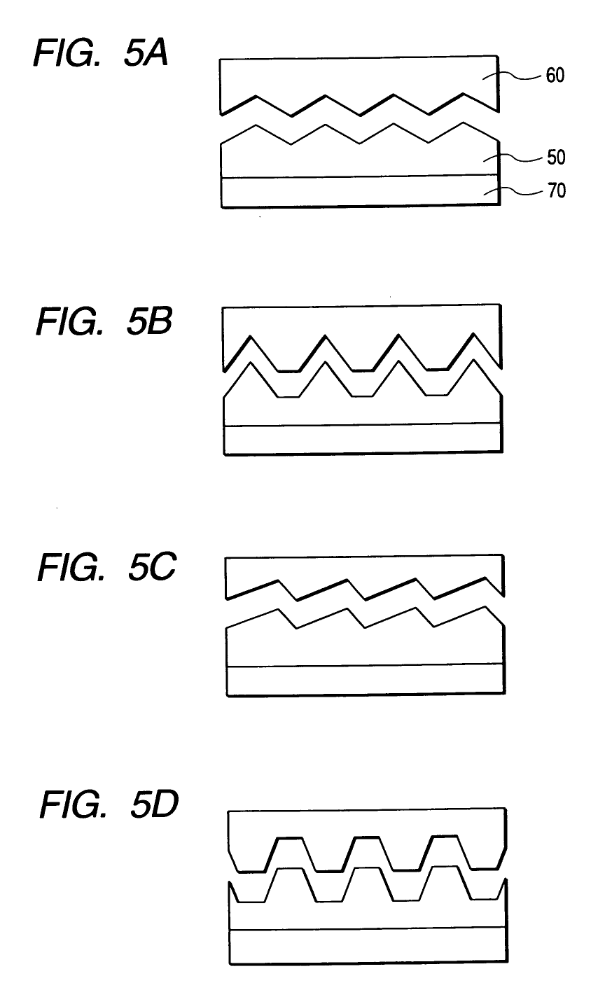

A linear prismatic structure is formed on the surface of a substrate according to a molding method. FIGS. 5A through 5D show examples of the molding mold usable in this case and those of the linear prismatic structure surface-having substrate formed, each as a cross-sectional profile perpendicular to the ridge direction of the prismatic structure. In this Example, used is a shaping mold having a cross section of an isosceles triangular prismatic structure as in FIG. 5A. If desired, however, any other various shapes as in FIGS. 5B to 5D are also usable for forming other various prismatic structures.

A production process is described. First, using a spin coater, a tetraethoxysilane (TEOS) sol film is formed on a quartz glass substrate 70, to which a shaping mold 60 is pressed. Under the condition, this is heated and dried, and then, the mold 60 is removed. After this operation, the substrate is heated at 600° C. whereby a prismatic structure film 50 comprising mainly SiO₂ is formed on the glass substrate 70. This is used as a substrate.

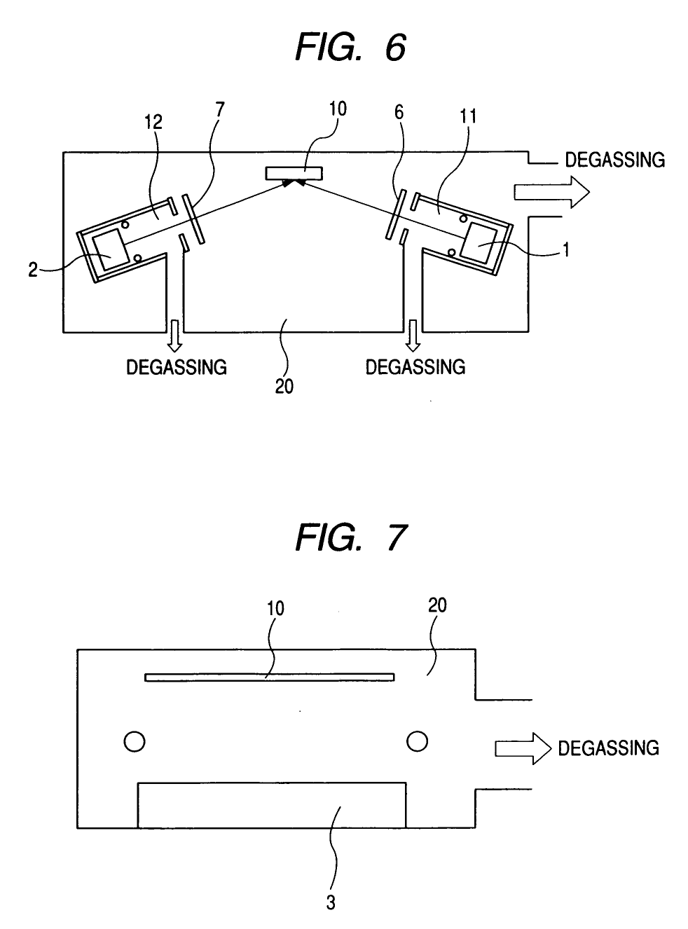

Next, an Al target is fitted to the magnetron cathode 1 of a distant sputtering device shown in FIG. 6, and an SiO₂ target to the magnetron cathode 2. The above prismatic structure-having quartz glass substrate is fitted to the substrate site 10 shown in FIG. 6. The magnetron cathode 1 is positioned, as inclined at 80° to the normal ridge direction of the substrate 10; and the magnetron cathode 2 is at 80° thereto.

Next, using a rotary pump and a cryopump, the sputtering chamber 20 is degassed to a pressure of about 1×10⁻³Pa. Argon gas is introduced into the target chamber 11, and argon gas is also into the target chamber 12. In this step, the pressure inside the sputtering chamber is 3×10⁻² Pa. Next, a negative voltage is applied to the magnetron cathode 1 from a direct current power source, thereby causing glow discharge. Further, high frequency (13.56 MHz) is applied to the magnetron cathode 2, thereby also causing glow discharge.

Next, on the surface of the substrate 10, the power to be supplied to the magnetron cathode 1 is so controlled that the Al deposition speed (tabular metal growth speed) could be 10 nm/min. Further, the high frequency power to be supplied to the magnetron cathode 2 is so controlled that the SiO₂ film deposition speed on the surface of the substrate 10 could be 10 nm/min.

Next, the shutter 6 and 7 set in front of the magnetron cathode 1 and the magnetron cathode 2, respectively, are opened at the same time to start the film formation, and this condition is kept as such for about 10 minutes. After 10 minutes, the two shutters 6 and 7 are closed at the same time, and the film formation is thus finished.

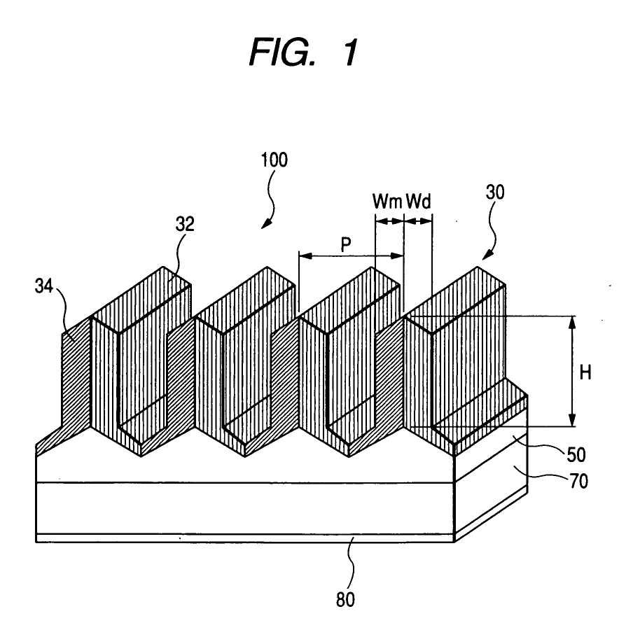

The cross section of the thus-formed thin film structure is observed with a transmission electronic microscope (TEM), and its perspective view is as in FIG. 1. On the surface of the prismatic structure film 50 formed on the glass substrate 70, tabular members 30 each comprising a tabular dielectric layer 32 of mainly SiO₂ and a tabular metal layer 34 of mainly Al combined in contact with each other are aligned in the ridge direction of the hilltops of the prismatic structure film 50.

Analyzing the tabular dielectric layer and the tabular metal layer for their constitutive components has revealed that, as a minor impurity therein, the dielectric layer contains the constitutive component of the metal layer and the metal layer contains that of the dielectric layer. The main component of the layer as referred to herein means the essential ingredient of the layer except the impurity.

When the height of the tabular member 30 is represented by H, the pitch of the tabular members 30 is by P, the thickness of the metal (Al) layer 34 is by Wm, and the thickness of the dielectric (SiO₂) layer 32 is by Wd, then it is found that H is about 100 nm, P is 100 nm, Wm is 45 nm and Wd is 45 nm.

On the back of the glass substrate 70 with the above-mentioned film formed on the surface thereof, a four-layered antireflection film 80 of TiO₂ and SiO₂ is formed according to a sputtering process. As a result, the reflectance on the back of the substrate is not more than 1% within a wavelength range of from 400 nm to 700 nm.

The polarization transmittance of the structure is measured, at an incident light wavelength of 440 nm, 540 nm or 700 nm. In this, the light of which the electric field amplitude face is parallel to the face direction of the tabular member 30 (that is, parallel to the ridge direction of the prismatic structure of the substrate) is referred to as TE-mode light (TE-polarized light); and the light of which the electric field amplitude face is perpendicular to the face direction of the tabular member 30 is referred to as TM-mode light (TM-polarized light). The sample is analyzed for the polarization of the two modes, using a spectrophotometer. The data are shown in Table 1 in the column of the thin film structure A. The extinction coefficient is represented by the following equation:
Extinction Coefficient (dB)=¹⁰·log(T_{TM}/T_{TE})
wherein T_{TM} indicates a TM-mode polarization light transmittance, and T_{TE} indicates a TE-mode polarization light transmittance.

### EXAMPLE 1

The thin film structure A is again introduced into the sputtering device, disposed as in FIG. 7. An SiO₂ target is fitted to the magnetron cathode 3 at the position of the substrate 10. Next, using a rotary pump and a cryopump, the sputtering chamber is degassed to a pressure of about 1×10⁻³ Pa. Argon gas mixed with 2% oxygen gas is introduced into the sputtering chamber 11, and the pressures inside the sputtering chamber is controlled to 1 Pa. Next, high frequency (13.56 MHz) is applied to the magnetron cathode 3, thereby causing glow discharge. In about 3 minutes, an SiO₂ film is deposited on the structure. In this case, the film formation is under a non-directional condition, and therefore a tabular member is not formed. The SiO₂ film (refractive index: 1.46) is formed to cover the thin film structure A.

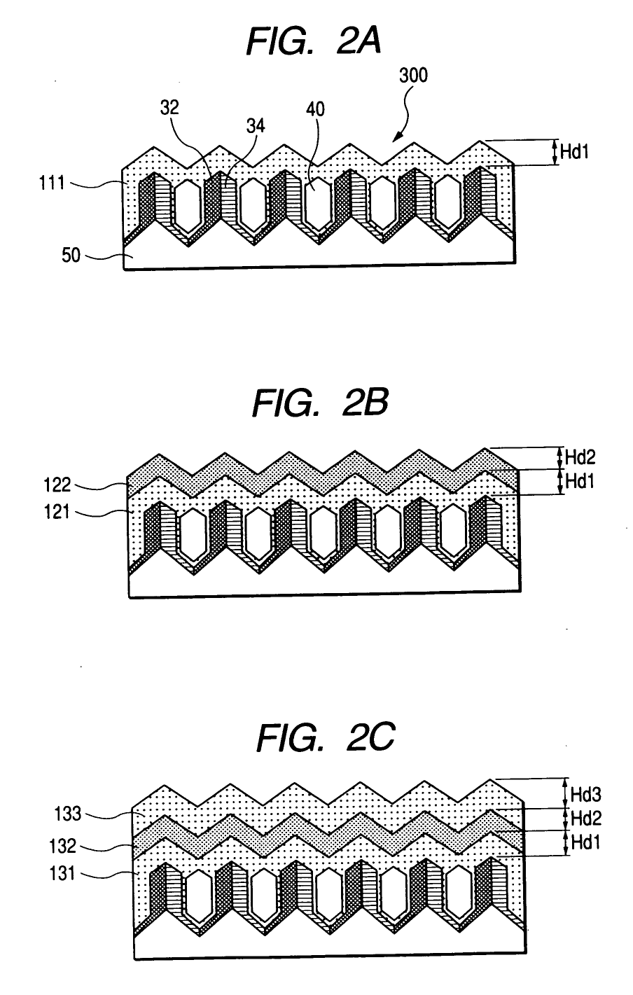

The crosssection of the thus-formed thin film structure 100 is a gain observed with a transmission electronic microscope. This has a structure as in FIG. 2A, in which the surface of the thin film structure A shown in FIG. 1 is covered with a transparent dielectric (SiO₂) film 111. Defined as in FIG. 2A, the film thickness Hd1 of the SiO₂ layer is about 75 nm. Voids 40 remain in the structure.

The polarization light transmittance of the thin film structure 100 is determined at an incident light wavelength of 440 nm, 540 nm or 700 nm. The data are given in Table 2. When compared with that of the thin film structure A not coated with the SiO₂ layer, the TM-mode light transmittance at each wavelength has significantly increased from 80.8% to 86.6% at λ=440 nm, from 72.8% to 89.2% at λ=540 nm, and from 69.9% to 80.8% at λ=700 nm.

On the other hand, the TE-mode light transmittance has increased slightly from 0.16% to 0.25% at λ=440 nm, from 0.08% to 0.15% at λ=540 nm, and from 0.04% to 0.06% at λ=700nm. Since the increase in the TE-mode light transmittance is only a little, the reduction in the extinction coefficient to be caused by the formation of the transparent dielectric film is also onlya little. Specifically, it is confirmed that the formation of the transparent dielectric film is effective for increasing the TM-mode light transmittance. The thin film structure 100 can be used as a polarizer for visible light.

### Examples 2 to 4

In Examples 2 to 4, a transparent dielectric film having a film constitution mentioned below is formed to cover the surface of a thin film structure A. As shown in the drawings, the film thickness of each layer is represented by Hd1, Hd2 and Hd3 in that order from the side of the thin film structure.

### EXAMPLE 2

Al₂O₃ (Hd1=166 nm, refractive index: 1.64)/SiO₂ (Hd2=94 nm)

### EXAMPLE 3

Al₂O₃ (Hd1=83 nm) /SiO₂ (Hd2=94 nm)

### EXAMPLE 4

Al₂O₃ (Hd1=83 nm)/TiO₂ (Hd2=115 nm, refractive index: 2.50)/SiO₂ (Hd2=94 nm)

A schematic cross-sectional view of each thin film structure is shown in FIGS. 2B and 2C (in which the transparent dielectric film is represented by numeral references 121 to 133). Like the structure of Example 1, these structures are analyzed and tested for their profile and transmittance data, and the results are given in Table 2. It is confirmed that, of every thin film structure having the film constitution of Examples 2 to 4, the transmittance has increased as compared with that of the thin film structure A, and there is not any significant change in the extinction coefficient thereof. These thin film structures are also usable as a polarizer for visible light.

### COMPARATIVE EXAMPLE 1

In Comparative Example 1, a thin film structure A is coated with a single-layered transparent film of TiO₂ having a thickness Hd1 of 100 nm.

The schematic cross-sectional view of the thus-coated structure is as in FIG. 2A (in which 111 indicates the transparent dielectric film). Like that of Example 1, the structure is analyzed and tested for its profile and transmittance data, and the results are given in Table 2. It is confirmed that the extinction coefficient of this structure has increased as compared with that of the thin film structure A, but the transmittance thereof has significantly decreased. Accordingly, the structure is difficult to use as a polarizer for visible light.

### EXAMPLE 5

The space of a thin film structure A is filled with SiO₂ according to a sol-gel process. An SiO₂ film is formed to cover the surface of this structure according to a sputtering process. The polarization light transmittance of the resulting thin film structure is determined at an incident light wavelength of 440 nm, 540 nm or 700 nm. The data are given in Table 2.

When compared with that of the thin film structure A, the TM-mode light transmittance at each wavelength has significantly increased from 80.8% to 84.5% at λ=440 nm, from 72.8% to 87.6% at λ=540 nm, and from 69.9% to 78.1% at λ=700 nm. On the other hand, the TE-mode light transmittance has changed little. As a result, the reduction in the extinction coefficient of the coated structure is only a little, and, it is therefore confirmed that the coating film is effective for significantly increasing the TM-mode light transmittance of the coated structure. The thin film structure is usable as a polarizer for visible light.

### Second Embodiment

Like the first embodiment thereof, the second embodiment of the invention is a polarizer for use in a visible light wavelength range, which comprises, as the basic structure thereof, a thin film structure B of tabular metal parts formed and regularly aligned on a prismatic structure substrate.

(Thin Film Structure B)

The same substrate as in the thin film structure A is used.

The film formation mode in this embodiment differs from that in Example 1 in that an Al target is fitted to the magnetron cathode 1 and also to the magnetron cathode 2 of the distant sputtering device of FIG. 6 used in this embodiment. The power to be supplied to the magnetron cathode 1 and to the magnetron cathode 2 is so controlled that the Al deposition speed (tabular metal growth speed) on the surface of the substrate 10 could be 30 nm/min. The time for film formation is about 4 minutes.

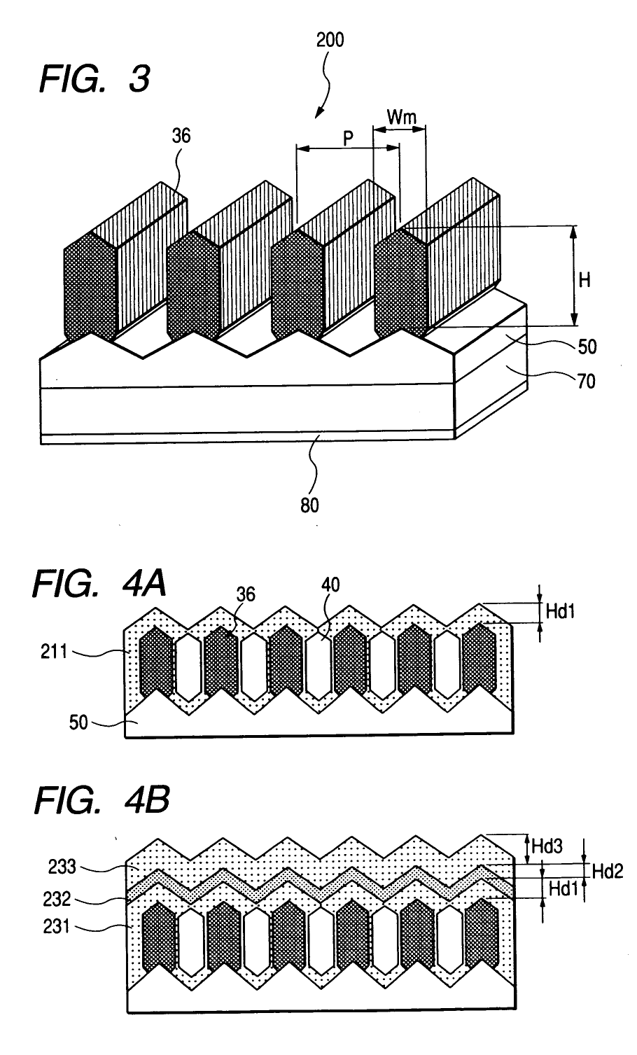

The cross section of the thus-formed thin film structure B is observed with a transmission electronic microscope (TEM), and its perspective view is as in FIG. 3. On the prismatic structure film 50, tabular metal structures 36 of mainly Al are aligned independently of each other to form separate prismatic hills. When the height of the tabular member is represented by H, the pitch of the aligned tabular members is by P, the thickness of structure is by Wm, then, it is found that H is about 120 nm, P is 120 nm and Wm is 60 nm.

Like that for the thin film structure A, a four-layered antireflection film 80 of TiO₂ and SiO₂ is formed on the back of the glass substrate 70. The TM-mode light transmittance and the TE-mode light transmittance of the structure in this condition are measured. The data are shown in Table 1 in the column of the thin film structure B.

### EXAMPLE 6

A single-layered SiO₂ film 211 having a thickness of 75 nm is formed on the surface of the thin film structure B thus constructed in the manner as above, using the film-forming device of FIG. 7. The schematic cross-sectional view of the thin film structure 200 is shown in FIG. 4A.

The structure is analyzed for its profile and transmittance data, and the results are given in Table 2. It is confirmed that the TM-mode light transmittance of the structure having the film constitution of this Example has increased at every wavelength used in the test, as compared with that of the thin film structure B, and the extinction coefficient of the coated structure does not change as compared with that of the non-coated structure B. The thin film structure of this Example is also usable as a polarizer for visible light.

### EXAMPLE 7

This Example differs from Example 6 only in that the layer constitution of the transparent dielectric film is changed to the following:
Al₂O₃(Hd1=83 nm)/TiO₂ (Hd2=115 nm) /SiO₂ (Hd3=94 nm)

A schematic cross-sectional view of this thin film structure is shown in FIG. 4B. The thin film structure is composed of three layers 231, 232, 233. It is confirmed that the TM-mode light transmittance at a wavelength of 440 nm of this structure has decreased, but that at a wavelength of 540 nm and 700 nm has increased, as in Table 2, and the extinction coefficient of this structure is kept high. The thin film structure of this Example is also usable as a polarizer for visible light.

### COMPARATIVE EXAMPLES 2 AND 3

In Comparative Examples 2 and 3, a transparent dielectric film having a film constitution mentioned below is formed to cover the surface of a thin film structure B.

### COMPARATIVE EXAMPLE 2

ZnO (Hd1=75 nm, refractive index; 1.84)

### COMPARATIVE EXAMPLE 3

TiO₂(Hd1=100 nm)

The schematic cross-sectional view of each thin film structure is shown in FIG. 4A. Like that in Example 6, the structures are analyzed and tested for their profile and transmittance data, and the results are given in Table 2. The transmittance of the film structure of Comparative Examples 2 and 3 has greatly decreased as compared with that of the thin film structure B. Accordingly, the thin film structures of Comparative Examples 2 and 3 are impossible to use as a polarizer for visible light.

### Third Embodiment

The third embodiment of the invention is a polarizer for use in a near IR range (wavelength 1550 nm) for optical communication.

(Thin Film Structure C)

Like that for the thin film structure A, a thin film structure C having polarization capability is constructed. An antireflection film of TiO₂ and SiO₂ is formed on the back of a glass substrate so that the reflectance thereon could be 0.1% at a wavelength of 1550 nm.

Next, the cross section of the thin film structure having polarization capability is confirmed with a transmission electronic microscope. It is confirmed that the structure has a cross-sectional profile as in FIG. 1, in which the pitch P=270 nm, the height of the tabular member H=360 nm, the thickness of the metal (Ag) layer Wm=100 nm, and the thickness of the dielectric (SiO₂) layer Wd=90 nm. The thin film structure having the constitution as above is analyzed for its optical property for polarization, using a semiconductor laser at a wavelength of 1550 nm through a Glan-Thompson prism. The data of the TM-mode light transmittance and the TE-mode light transmittance of the structure are shown in Table 1 in the column of the thin film structure C.

(Thin Film Structure D)

In the same manner as that for the thin film structure C, a thin film structure D is constructed in which, however, the height (H) of the tabular member is two times, 720 nm. Its optical properties are shown in Table 1.

### EXAMPLE 8

In this Example, a thin film structure C is coated with an SiO₂ film having a thickness Hd1=220 nm. The schematic cross-sectional view of the thin film structure is the same as in FIG. 2A. Next, using a semiconductor laser at a wavelength of 1550 nm through a Glan-Thompson prism, the structure is analyzed for its optical property for polarization. The data are given in Table 2. It is understood that the TM-mode light transmittance of the structure has increased by about 7% and the extinction coefficient thereof has changed little, and the structure keeps good properties. The thin film structure of this Example is usable as a polarizer for IR rays.

### COMPARATIVE EXAMPLE 4

In Comparative Example 4, a thin film structure C is coated with a film of ZnO having a thickness Hd1=160 nm. Like that in Example 8, the structure is analyzed for its profile and transmittance, and the data a regiven in Table 2. As compared with that of the thin film structure C, the transmittance of the film structure of Comparative Example 4 has greatly decreased. Accordingly, the thin film structure of this Comparative Example is unsuitable for a polarizer for IR rays.

### EXAMPLE 9

In this Example, a thin film structure D is coated with an SiO₂ film having a thickness Hd1=280 nm. Its data are given in Table 2. It is understood that the TM-mode light transmittance of the SiO₂-coated structure has increased by about 9% and the extinction coefficient thereof has changed little, and the structure keeps good properties. The thin film structure of this Example is also usable as a polarizer for IR rays.

### COMPARATIVE EXAMPLE 5

In this Comparative Example, a thin film structure D is coated with a film of ZnO having a thickness Hd1=200 nm. Like that in Example 9, the structure is analyzed for its profile and transmittance, and the data a regiven in Table 2. As compared with that of the thin film structure D, the transmittance of the film structure of Comparative Example 5 has decreased. Accordingly, the thin film structure of this Comparative Example is unsuitable for a polarizer for IR rays.

TABLE 1

| | | Film | Metal | | | | | | | | | Extinction |
|---|---|---|---|---|---|---|---|---|---|---|---|---|
| Thin Film | Pitch | Thickness | Width | Dielectric | | Dielectric | | Back | Wavelength | T_{TE} | T_{TM} | Coefficient |
| Structure | (P) | (H) | (Wm) | Width (Ds) | Metal | Material | Substrate | AR | (nm) | (%) | (%) | (dB) |
| A | 100 nm | 100 nm | 45 nm | 45 nm | Al | SiO₂ | SiO₂ | yes | 440 | 0.1696 | 80.84 | 26.78 |
| | | | | | | | | | 540 | 0.0804 | 72.76 | 29.57 |
| | | | | | | | | | 700 | 0.0378 | 69.85 | 32.67 |
| B | 120 nm | 120 nm | 60 nm | 0 nm | Al | no | SiO₂ | yes | 440 | 0.0268 | 85.06 | 35.01 |
| | | | | | | | | | 540 | 0.0148 | 80.88 | 37.38 |
| | | | | | | | | | 700 | 0.0077 | 78.98 | 40.12 |
| C | 270 nm | 360 nm | 100 nm | 90 nm | Ag | SiO₂ | SiO₂ | yes | 1550 | 0.0022 | 90.63 | 46.07 |
| D | 270 nm | 720 nm | 100 nm | 90 nm | Ag | SiO₂ | SiO₂ | yes | 1550 | 0.0000 | 85.86 | >70 |

TABLE 2

| | | | | | | Extinction |
|---|---|---|---|---|---|---|
| | Thin Film | Constitution of | Wavelength | T_{TE} | T_{TM} | Coefficient |
| | Structure | Transparent Film | (nm) | (%) | (%) | (dB) |
| Example 1 | A | SiO₂ (75 nm) | 440 | 0.2517 | 86.64 | 25.37 |
| | | | 540 | 0.1489 | 89.20 | 27.77 |
| | | | 700 | 0.0659 | 80.81 | 30.89 |
| Example 2 | A | Al₂O₃ (166 nm)/ | 440 | 0.0535 | 81.37 | 31.82 |
| | | SiO₂ (94 nm) | 540 | 0.1128 | 87.59 | 28.90 |
| | | | 700 | 0.2367 | 79.98 | 25.29 |
| Example 3 | A | Al₂O₃ (83 nm)/ | 440 | 0.0885 | 87.44 | 29.95 |
| | | SiO₂ (94 nm) | 540 | 0.0902 | 79.86 | 29.47 |
| | | | 700 | 0.1982 | 84.48 | 26.30 |
| Example 4 | A | Al₂O₃ (83 nm)/ | 440 | 0.0444 | 81.65 | 32.64 |
| | | TiO₂ (115 nm)/ | 540 | 0.0859 | 81.12 | 29.75 |
| | | SiO₂ (94 nm) | 700 | 0.2250 | 88.56 | 25.95 |
| Comparative | A | TiO₂ (100 nm) | 440 | 0.0055 | 42.28 | 38.87 |
| Example 1 | | | 540 | 0.0007 | 66.10 | 49.78 |
| | | | 700 | 0.0004 | 77.83 | 52.90 |
| Example 5 | A | SiO₂ (75 nm) | 440 | 0.2774 | 84.51 | 24.84 |
| | | | 540 | 0.1606 | 87.57 | 27.37 |
| | | | 700 | 0.0699 | 78.12 | 30.49 |
| Example 6 | B | SiO₂ (75 nm) | 440 | 0.0418 | 85.88 | 33.13 |
| | | | 540 | 0.0279 | 89.77 | 35.08 |
| | | | 700 | 0.0135 | 84.76 | 37.98 |
| Example 7 | B | Al₂O₃ (83 nm)/ | 440 | 0.0255 | 74.89 | 34.68 |
| | | TiO₂ (115 nm)/ | 540 | 0.0179 | 84.55 | 36.75 |
| | | SiO₂ (94 nm) | 700 | 0.0105 | 84.43 | 39.05 |
| Comparative | B | ZnO (75 nm) | 440 | 0.0041 | 59.95 | 41.64 |
| Example 2 | | | 540 | 0.0046 | 77.32 | 42.23 |
| | | | 700 | 0.0039 | 79.77 | 43.06 |
| Comparative | B | TiO₂ (100 nm) | 440 | 0.0137 | 10.05 | 28.64 |
| Example 3 | | | 540 | 0.0022 | 46.43 | 43.24 |
| | | | 700 | 0.0016 | 70.15 | 46.53 |
| Example 8 | C | SiO₂ (220 nm) | 1550 | 0.0044 | 97.13 | 43.42 |
| Comparative | C | ZnO (160 nm) | 1550 | 0.0075 | 86.22 | 40.63 |
| Example 4 | | | | | | |
| Example 9 | D | SiO₂ (280 nm) | 1550 | 0.0000 | 94.90 | >70 |
| Comparative | D | ZnO (200 nm) | 1550 | 0.0000 | 85.38 | >70 |
| Example 5 | | | | | | |

(Total Evaluation)

In Examples 1, 6, 8 and 9, a transparent single-layered film of SiO₂ having a refractive index of 1.46 is formed on a thin film structure. The coated structures are all good in that their TM-mode light transmittance of has increased as compared with that of the non-coated structure and their extinction coefficient has changed little. As opposed to these, in Comparative Examples 1 to 5, a single-layered film of TiO₂ having a refractive index of 2.50 or a single layered film of ZnO having a refractive index of 1.84 is formed on a thin film structure. In these, however, the TM-mode light transmittance of the coated structures has decreased as compared with that of the non-coated structure. Accordingly, when a single-layered transparent film is formed on the thin film structure, then its refractive index is preferably not more than 1.8 irrespective of the wavelength range where the structure is to be in service.

From Examples 1 and 6, it is understood that the two-layered tabular member of metal and dielectric material and the single-layered tabular member of metal both attain the same effect.

In Examples 2 and 3, the transparent film has a two-layered structure, in which the first layer adjacent to the thin film structure is of Al2O₃ having a refractive index of 1.64 and the second layer is of SiO₂ having a refractive index of 1.46. In such a two-layered structure, it is desirable that the first layer adjacent to the thin film structure has a refractive index of from 1.6 to 1.9 and the second layer has a refractive index of not more than 1.5.

In Examples 4 and 7, the transparent film has a three-layered structure, in which the first layer adjacent to the thin film structure is of Al₂O₃ having a refractive index of 1.64, the second layer is of TiO₂ having a refractive index of 2.50 and the third layer is of SiO₂ having a refractive index of 1.46. In such a three-layered structure, it is desirable that the first layer adjacent to the thin film structure has a refractive index of from 1.6 to 1.9, the second layer has a refractive index of from 2.2 to 2.7 and the third layer has a refractive index of not more than 1.5.

In the thin film structures A and B, aluminum is used for the metal to constitute the tabular member; and in the thin film structures C and D, silver is used for it. Apart from these, copper, platinum, gold or an alloy comprising mainly any of these metals is also usable herein.

In the thin film structures A, C and D, silicon dioxide (SiO₂) is used for the dielectric layer of the tabular member. Apart from it, magnesium fluoride (MgF₂) or the like is also usable herein.

In Example 5, the space between the tabular members is filled with a dielectric material, and this attains the same result as herein. The dielectric material actually used herein is SiO₂ having a refractive index of 1.46. Preferably, the dielectric material for use for this purpose has a refractive index of not more than 1.6.

What is claimed is:

1. A polarizer comprising:
a thin film structure including a transparent substrate on which a linear prismatic surface is formed,
a plurality of tabular members formed on the linear prismatic surface of said transparent substrate so as to be in parallel with one another and so as to define a predetermined angle between each of the tabular members and the prismatic surface, wherein one edge of each tabular member is in contact with said transparent substrate along a ridge direction of the linear prismatic structure; and
a transparent film provided on said thin film structure, covering the tabular members on another edges thereof that are opposite to said one edges in contact with said transparent substrate, and
wherein said transparent film is configured that an increase in TM-mode polarization light transmittance of said thin film structure from that of a thin film structure on which a transparent film is not provided, is larger than an increase in TE-mode polarization light transmittance of said thin film structure from that of a thin film structure on which a transparent film is not provided.

2. A polarizer according to claim 1, wherein each tabular member is formed of a metal material as main component.

3. A polarizer according to claim 1, wherein each tabular member is composed of a layer of mainly a metal material and a layer of mainly a dielectric material that are integrated to each other.

4. A polarizer according to claim 1, wherein said transparent film is a single-layered film formed of a single material or a multi-layered film formed of plural different materials.

5. A polarizer according to claim 4, wherein said transparent film is a single-layered film formed of a single material whose refractive index is not more than 1.8.

6. A polarizer according to claim 4, wherein said transparent film is a two-layered film formed of two different materials, and a refractive index of a first layer thereof on a side of said thin film structure is from 1.6 to 1.9 and a refractive index of a second layer thereof is not more than 1.5.

7. A polarizer according to claim 4, wherein said transparent film is a three-layered film formed of three different materials, and a refractive index of a first layer thereof on a side of said thin film structure is from 1.6 to 1.9, a refractive index of a second layer thereof formed on the first layer is from 2.2 to 2.7 and a refractive index of a third layer thereof is not more than 1.5.

8. A polarizer according to claim 1, wherein a four-layered film is formed on aback surface of said transparent substrate, and said four-layered film is formed of two or more different materials, and a refractive index of a first layer thereof on a side of the thin film structure is from 2.2 to 2.7, a refractive index of a second layer thereof formed on the first layer is not more than 1.5, a refractive index of a third layer thereof formed on the second layer is from 2.2 to 2.7 and a refractive index of a fourth layer formed on the third layer thereof is not more than 1.5.

9. A polarizer according to claim 2, wherein the metal material includes one of silver, aluminum, copper, platinum and gold, or an alloy formed mainly of one of said metals.

10. A polarizer according to claim 3, wherein the dielectric material is a material including silicon dioxide as main component, or a material including magnesium fluoride as main component.

11. A polarizer according to claim 1, wherein a space between the adjacent tabular members is filled with a transparent dielectric material having a refractive index of not more than 1.6.

12. A method for producing a polarizer, comprising the steps of:
impinging a) an ion, an atom or a cluster of a metal element on a linear prismatic structure on a substrate at a predetermined angel to a ridge direction of the linear prismatic structure and in a direction oblique to a normal direction of a surface of the prismatic substrate, and simultaneously, b) an ion, an atom or a cluster of the metal element on said linear prismatic structure on an opposite side thereof with respect to a normal face of the surface of the prismatic substrate that is in parallel with a ridge direction of the prismatic structure,
forming tabular members each of which includes a metal as main component thereof on the linear prismatic structure of said transparent substrate, and
forming at least one transparent dielectric layer on the tabular members according to a non-directional film-forming process.

13. A method for producing a polarizer, comprising the steps of:
impinging a) an ion, an atom or a cluster of a metal element on a linear prismatic structure on a substrate at a predetermined angel to a ridge direction of the linear prismatic structure and in a direction oblique to a normal direction of a surface of the prismatic substrate, and simultaneously, b) an ion, an atom or a cluster of another element on said linear prismatic structure on an opposite side thereof with respect to a normal face of the surface of the prismatic substrate that is in parallel with a ridge direction of the prismatic structure,
forming tabular members each of which is composed of a layer of mainly a metal material and a layer of mainly a dielectric material that are integrated to each other on the linear prismatic structure of said transparent substrate, and
forming at least one transparent dielectric layer on the tabular members according to anon-directional film-forming process.

14. The method for producing a polarizer according to claim 12, wherein TM-mode polarization light transmittance and TE-mode polarization light transmittance of a thin film structure that comprises said tabular members formed on said transparent substrate are determined as reference values, and said transparent dielectric layer is configured that said transparent film is configured that an increase in TM-mode polarization light transmittance of said thin film structure from the reference value of TM-mode polarization light transmittance, is larger than an increase in TE-mode polarization light transmittance of said thin film structure from the reference value of TM-mode polarization light transmittance.
